(19) United States
(12) Patent Application Publication
(10) Pub. No.: US 2023/0325497 A1
(43) Pub. Date: Oct. 12, 2023

(54) WATERMARK PROTECTION OF ARTIFICIAL INTELLIGENCE MODEL

(71) Applicant: Telefonaktiebolaget LM Ericsson (publ), Stockholm (SE)

(72) Inventors: N Hari Kumar, CHENNAI (IN); Akshara Kannan, CHENNAI (IN); Mrudula B, CHENNAI (IN); Nivedha M, CHENNAI (IN)

(21) Appl. No.: 18/016,468

(22) PCT Filed: Jul. 23, 2020
(86) PCT No.: PCT/IN2020/050636

§ 371 Date: Jan. 17, 2023

(51) Int. Cl. G06F 21/55

(52) U.S. Cl. CPC G06F 21/554; G06F 2221/034

(57) ABSTRACT

A computer-implemented model for protecting an artificial intelligence (AI) model from tampering is provided. The method includes determining a convergence of the AI model. The method further includes, responsive to the determining, identifying a set of baseline parameters of the converged AI model. The method further includes generating a first watermark for the converged AI model based on applying one or more transformations to each baseline parameter from the set of baseline parameters, wherein the first watermark comprises a value external to the converged AI model.

### TECHNICAL FIELD

The present disclosure relates generally to computer-implemented methods for watermark protection of an artificial intelligence (Al) model, and related methods and apparatuses.

### BACKGROUND

A watermark is a labelling technology/property that can be employed to uniquely identify a digital entity. Digital watermarking has been used for unambiguously establishing ownership of multimedia content and detecting external tampering. In the field of Al, watermarking methods have been devised for Internet of Things (IoT) devices, machine learning models and neural networks (collectively referred to herein as a “model”) to try to tackle an attack(s) from adversaries who either attempt to steal the model or disrupt the model’s working. Some approaches have used the technique of (1) embedding an ownership signature as the watermarking content in the model’s parameters; or (2) embedding a watermark as a pre-trained input-output pair for a model.

### SUMMARY

Vulnerabilities may exist regarding watermark embedding techniques. An attacker with privileged access to an entire Al model (e.g., a neural network) and thus an embedded watermark, can potentially overwrite the watermark by re-training the model, and altering its parameters without affecting its accuracy. Furthermore, an embedded watermark can be removed during model pruning and fine-tuning. For a model watermarked using pre-trained input-output pairs, a vulnerability lies in explicit availability of watermarked inputs, and recognizability of pre-trained output labels.

To address the forgoing problems, disclosed is a computer-implemented method for protecting an Al model from tampering. The method includes determining a convergence of the Al model. The method further includes, responsive to the determining, identifying a set of baseline parameters of the converged Al model. The method further includes generating a first watermark for the converged Al model based on applying one or more transformations to each baseline parameter from the set of baseline parameters, wherein the first watermark comprises a value external to the converged Al model.

In some embodiments, further operations include storing the first watermark in a repository separate from the converged Al model.

In some embodiments, further operations include determining, on a layer-by-layer basis, a count representing a number of neurons in each layer of the converged neural network based on a function of the number of input features in each layer and the number of output features in each layer, the function comprising a ratio of the number of input values in each layer to the number of output values in each layer. The operations further include identifying, on a layer-by-layer basis, one or more promising neurons based on a neuron ranking algorithm.

In some embodiments, further operations include determining a degree of correlation between the first watermark and a second watermark for another Al model, wherein the degree of correlation comprises a measure of whether the another Al model matches or is derived from the converged Al model.

In some embodiments, further operations include acquiring a set of baseline parameters from the another Al model. Further operations include generating the second watermark for the another Al model based on applying one or more transformations to each baseline parameter from a set of baseline parameters from the another Al model.

In some embodiments, further operations include determining, on a layer-by-layer basis, a count representing a number of neurons in each layer of the another neural network based on a function of the number of input features in each layer and the number of output features in each layer, the function comprising a ratio of the number of input values in each layer to the number of output values in each layer. The operations further include extracting, on a layer-by-layer basis, one or more neurons of the another neural network based on a ranking of the one or more neurons to identify the neurons for use in generating the second watermark.

In some embodiments, further operations include generating an alert notification that the another Al model matches or is derived from the converged Al model.

Corresponding embodiments of inventive concepts for an Al protection system, computer program products, and computer programs are also provided.

In some approaches, embedded watermarks are vulnerable to removal or tampering.

Various embodiments of the present disclosure may provide solutions to the foregoing and other potential problems. Various embodiments include a watermark completely outside the working of a model. As a consequence of being non-local to the model, the watermark may not be vulnerable to removal or tampering as dependency between the model and the watermark is eliminated.

Further potential advantages provided by various embodiments of the present disclosure may include that, by providing a watermark outside the working model, it may be possible to eliminate dependency between the model and the watermark, and thus provide a more robust watermarking architecture. The method also provides a generalized framework for watermarking that can be deployed for all neural networks. Moreover, by selecting the most promising neurons of a neural network to participate in the process, the watermark can account for integral portions of the neural network. Selecting the promising neurons can be performed only once by the owner before deploying the model as a service. The promising neuron selection process can also safeguard the model against model fine-tuning and pruning.

### BRIEF DESCRIPTION OF DRAWINGS

The accompanying drawings, which are included to provide a further understanding of the disclosure and are incorporated in and constitute a part of this application, illustrate certain non-limiting embodiments of inventive concepts. In the drawings:

FIG. 1 is a diagram illustrating a communication network including an Al protection system for a first neural network and further including a second neural network in accordance with various embodiments of the present disclosure;

FIG. 2 illustrates an operational view of the Al protection system that is processing baseline parameters of a first neural network in accordance with some embodiments of the present disclosure;

FIG. 3 illustrates elements of a first neural network which are interconnected and configured to operate in accordance with some embodiments;

FIG. 4 is a block diagram and data flow diagram of a first neural network that can be used in the Al protection system to generate a watermark in accordance with some embodiments;

FIG. 5 is a block diagram of operational modules and related circuits and controllers of the Al protection system that are configured to operate during the generation and verification of a watermark in accordance with some embodiments;

FIGS. 6-8 are flow charts of operations that may be performed by the Al protection system in accordance with some embodiments; and

FIG. 9 illustrates an exemplary embodiment in a 3GPP context on a packet core for a 5G telecommunication network with the method of the present disclosure managed within NWDAF.

### DETAILED DESCRIPTION

Inventive concepts will now be described more fully hereinafter with reference to the accompanying drawings, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

The following description presents various embodiments of the disclosed subject matter. These embodiments are presented as teaching examples and are not to be construed as limiting the scope of the disclosed subject matter. For example, certain details of the described embodiments may be modified, omitted, or expanded upon without departing from the scope of the described subject matter.

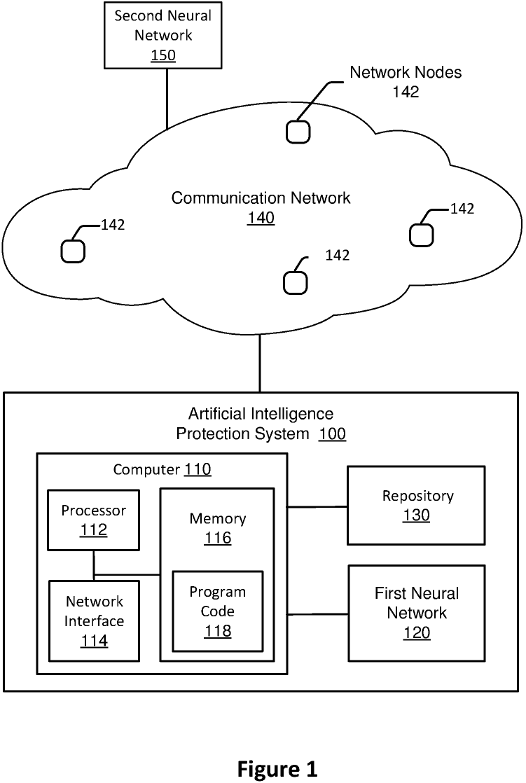

FIG. 1 illustrates an Al protection system 100 communicatively connected to a communication network including network nodes 142. The Al protection system 100 can generate a watermark for a first Al model (e.g., neural network 120) and verify the watermark against a watermark calculated for a second Al model (e.g., second neural network 150). The Al protection system 100 includes a repository 130, a first neural network 120, and a computer 110.

The computer 110 includes at least one memory 116 (“memory”) storing program code 118, a network interface 114, and at least one processor 112 (“processor”) that executes the program code 118 to perform operations described herein. The computer 110 is coupled to the repository 130 and the first neural network 120. The Al protection system 100 can be connected to communication network 140 and can acquire parameters of a second neural network 150 for generating a watermark of the second neural network 150. The Al protection system 100 can compare the generated watermark of the second neural network 150 to the watermark generated for first neural network 120. More particularly, the processor 112 can be connected via the network interface 114 to communicate with the second neural network 150 and the repository 130.

The processor 112 may include one or more data processing circuits, such as a general purpose and/or special purpose processor (e.g., microprocessor and/or digital signal processor) that may be collocated or distributed across one or more networks. The processor 112 may include one or more instruction processor cores. The processor 112 is configured to execute computer program code 118 in the memory 116, described below as a non-transitory computer readable medium, to perform at least some of the operations described herein as being performed by any one or more elements of the Al protection system 100.

The following explanation of potential problems with some approaches is a present realization as part of the present disclosure and is not to be construed as previously known by others. Embedded watermarks for Al models, such a neural network, may suffer from the following disadvantages:

Embedded watermarks can be removed during model pruning and fine-tuning. See e.g., Rouhani, Bita Darvish, Huili Chen and Farinaz Koushanfar. “DeepSigns: A Generic Watermarking Framework for IP Protection of Deep Learning Models.” IACR Cryptology ePrint Archive 2018 (2018): 311.z.

Embedded watermarked models using pre-trained input-output pairs cannot withstand modifications and wrappers written over the model. See e.g., Zhang, Jialong, et al. “Protecting intellectual property of deep neural networks with watermarking.” Proceedings of the 2018 on Asia Conference on Computer and Communications Security. ACM, 2018.

Embedded watermarking using model parameters may be vulnerable to modifications to parameters.

Embedding the watermark in a loss function poses a vulnerability of being accessible to the attacker in a case of a white box attack. A problem with embedding into a training dataset can be that the watermark is not robust against successive training of the model; thus, embedding a watermark in a training dataset can be ineffective in many practical situations. See e.g., Rouhani, Bita Darvish, Huili Chen and Farinaz Koushanfar. “DeepSigns: A Generic Watermarking Framework for IP Protection of Deep Learning Models.” IACR Cryptology ePrint Archive 2018 (2018): 311.z.

Various embodiments of the present disclosure may provide solutions to these and other potential problems. In various embodiments of the present disclosure, a method is provided for watermarking to establish ownership and to identify infringement of the ownership of an AI model (e.g., a neural network), in a way that may overcome exemplary attack scenarios referenced herein, such as embedded watermark removal and overwriting.

Due to the ubiquity of deep learning in today’s applications, and thus a need to ensure the security of such AI models, in various embodiments, the method includes qualities of a water retention functionality adapted to uniquely identify a neural network and establish its ownership.

Taking advantage of the physical structure of a neural network and concepts like retentivity, in various embodiments, the method includes a watermark completely outside the working of the model. Potential advantages provided by various embodiments of the present disclosure may include that, by providing a watermark outside the working model, it may be possible to eliminate dependency between the model and the watermark, and thus provide a more robust watermarking architecture. Additionally, the method provides a generalized framework for watermarking that can be deployed for all neural networks.

While various embodiments of the present disclosure are explained in the non-limiting context of a neural network, the invention is not so limited. Instead, the embodiments can apply across other AI models.

The boom of deep learning has vast implications across a range of industries. AI has become a key component for industries, which includes activities like acquiring massive amounts of data, preparing a data pipeline, and a machine learning (ML) pipeline. AI models can be cost and labor-intensive products which require significant expertise and computational resources. As a consequence, an AI model can pose a crippling vulnerability for developed AI models of an organization. An attacker’s main aim can be to steal an AI model and deploy its duplicate by changing the model slightly to suit the model to a new application; or change the functionality of the deployed model so that the model’s intentions are destroyed.

For example, two attack scenarios include (1) model fine-tuning, and (2) model pruning. A model fine-tuning attack can involve re-training the original model to alter the model parameters and find a new local minimum while preserving the accuracy. A model pruning attack can involve eliminating unnecessary connections between the layers of a neural network by setting the network parameters to zero in the weight tensor.

A digital watermark may need to satisfy minimal requirements. See e.g., Rouhani, Bita Darvish, Huili Chen and Farinaz Koushanfar. “DeepSigns: A Generic Watermarking Framework for IP Protection of Deep Learning Models.” IACR Cryptology ePrint Archive 2018 (2018): 311.z. Minimal requirements may include fidelity, robustness, integrity, and/or reliability. Fidelity includes that the functionality (e.g., accuracy) of the target neural network should not be degraded as a result of watermark embedding. Robustness includes resiliency of a watermarking method against model modifications such as compression/pruning, fine-tuning. Integrity refers to the watermarked model being uniquely identified using pertinent keys. Reliability of a watermarking method includes that the method can yield minimal false alarms (also known as, or referred to as, false positives).

As described further herein, a neural network can be visualized as a set of layers through which data flows. In various embodiments of the present disclosure, elements of such data flow can be used in generating a watermark. In some embodiments, characteristics of each layer of a neural network uniquely affects the watermark, where a generated watermarking value for a layer can be viewed as a measure of data retained by the layer (also referred to herein as retentivity), reflected in the model weights specific to the model under scrutiny.

In some embodiments, building on retentivity, base parameters ubiquitous to neural networks may be formulated into a characteristic equation which describes a watermark for the neural network.

In some embodiments, retentivity may provide a layer-wise watermark value that represents a factor of a number of manifolds associated with the current learning rate of a neural network. As used herein, the term “watermark” is used interchangeably with the terms “watermark measure”, “watermark value”, “watermark comprises a measure”, “watermark comprises a value”, “a value of a watermark”, and/or “a measure of a watermark”. Deep learning models are adaptive in size, exhibiting a large diversity in layer configuration. Consequently, a watermark’s dependency on such base parameters can result in a large range of values that the watermark can take. In various embodiments of the present disclosure, a value of a watermark is within a specific range of a threshold and, thus, the watermark can provide uniformity over a range of base parameters of the model. Moreover, as a consequence of establishing a co-dependence of the watermark on specified base parameters of the model, the watermark can correlate to a match of the watermark compared to a watermark generated for a target model, and thus can eliminate or reduce occurrences of false positives.

In some embodiments, components for generating a watermark are not individual parameters, but rather come together to describe the model as a functioning unit built and trained to perform a specific task.

In various embodiments, the generated watermark of a neural network quantifies a value that acts as a fingerprint or a unique characteristic of the model in question. The watermark figuratively corresponds to the amount of data that a layer can hold, when the data undergoes a series of transformations at each layer, or in other words the retentivity of the model.

In some embodiments, the watermark is generated for an original model (also referred to herein as a “baseline model”, “owner’s model”, “AI model”, a “first neural network”, a “first AI model”, a “first converged AI model”, “neural network”, and/or “converged AI model”) based on the following equation (“watermark equation”) and as further discussed herein:

$$W = l o {g}_{∝} \left(λ + \frac{{λ}_{0} - λ}{{\left[1 + {\left[\left(ω\right) \left(ρ\right)\right]}^{n}\right]}^{1 - 1 / n}}\right)$$

W watermark value
   |ρ| optimal baseline accuracy
λ₀ baseline model weights
λ recent model weights
ω number of training samples
n layer-wise neuron count
∝ learning rate of neural network

The watermark value is a representative value for a model which includes key or certain parameters of neural networks. The denominator can produce an S-shaped, symmetric curve of the watermarking value (W) versus accuracy (ρ), using model parameters such as baseline accuracy, training samples and neuron count. Such a curve can give rise to an even distribution of watermark values for a range of inputs. The term 1-⅟n is included to maintain the exponent value in the range of 0 to 1 as usually, n>1.

Baseline accuracy refers to the accuracy of the model at a point in training where changes to the model (in other words, further training or modification) do not produce significant improvement in its accuracy.

As described further herein, the watermark equation considers only the model weights of the most promising neurons in the watermark equation. The term “promising neurons” refers to neurons where removal of a certain number of these neurons from the model can result in the model ceasing to perform the intended functionality. Hence, the promising neurons are included in the watermark equation for defining a confidence interval for baseline accuracy. The confidence interval can be defined as the interval:
[accuracy of model on removal of ‘p’ promising neurons, accuracy of model without the removal of promising neurons].

Potential advantages provided by selecting promising neurons of a neural network may include that the generated watermark using the promising neurons may account for integral portions of the neural network, and the selection may be performed one time before deploying the model as a service. Additionally, the selection may safeguard the model against model fine-tuning and pruning.

In some embodiments. the value of the promising neurons ‘p’ is assigned to be equal to 2 empirically, although ‘p’ can vary according to the model or type of neural network.

Some recent watermarking approaches may not have considered a fact about the characteristics of many neural networks. Namely, owing to an assumption that a deployed model is trained to high accuracy, and is highly optimized, performing large modifications on the fine-tuned and pruned neural network defeats a purpose of the model as it renders the model incapable of performing its intended function. Hence, an attacker may only be able to make minor adjustments to the parameters of the model to get maximum benefits, which some approaches may not consider. Various embodiments of the present disclosure consider this and in providing a mechanism to verify the ownership of the model.

In Szyller, Sebastian, et al. “Dawn: Dynamic adversarial watermarking of neural networks” (2019), an attack scenario called Model Extraction is described where a surrogate model is learned by an adversary using the outputs of a query prediction application protocol interface (API) from an owner’s model (“described attack”). This realistic threat, which was modelled as a formalization in terms of active learning, produces a good approximation of the original model. Various embodiments of the present disclosure may protect a model from the described attack.

The watermark of various embodiments of the present disclosure may be robust against the described attack because the watermark value will not be overwritten or lost in the process of training the surrogate model. Whatever the level of capability of extraction attack, an adversary’s choices and attacking methods support in training the surrogate model to imitate the original model closely. The surrogate model would thus have its parameters and hyperparameters to be a strong approximation of those of the owner’s model, such that it performs the intended functionality with an accuracy as close as the original model resulting in the calculated watermark values to reflect the ownership.

An approach in Szyller, Sebastian, et al. “Dawn: Dynamic adversarial watermarking of neural networks” may have deficiencies when an adversary ignores a portion of the query results to reduce the accuracy of the watermark. This strategy can affect the process of establishing the model ownership, especially if the adversary has access to large computation and can afford a large number of queries. This problem may not arise in various embodiments of the present disclosure as a consequence of the independency of the model and watermark.

Adi, Yossi, et al. “Turning your weakness into a strength: Watermarking deep neural networks by backdooring” describes specifying an exception that a watermarking value pair can be discovered by an attacker with unlimited computational resources. In contrast, in accordance with various embodiments of the present disclosure, an attacker may have no knowledge of the existence of the watermark as the watermark is outside the model and, hence, the existence of unbounded resources for the attacker does not play a part in watermark discovery.

Uchida, Yusuke, et al. “Embedding watermarks into deep neural networks” discusses an embedding strategy for watermarking, where the watermark is embedded in the parameters of the model, using a parameter regularizer while training a neural network. Watermark overwriting is a vulnerability for this solution, where a different watermark can be used to overwrite the original watermark. In contrast, in accordance with various embodiments of the present disclosure, a watermark may be resilient to this attack scenario as the changes induced upon the values of the terms of the watermark equation may not produce significant changes in the watermark outside a threshold.

Watermark generation of the present disclosure includes generating the watermark using parameters from a known state of the model. The watermark can be generated using the watermark equation. Generation of the watermark can be performed only once by the owner before deploying the model as a service.

In some embodiments, watermark generation includes one or more of the following five operations.

First, baseline parameters of the model are identified, e.g., values of baseline parameters when the model has been subjected to some training. Preferably, the model is a neural network model.

The baseline parameters can include, without limitation, one or more of the following: baseline accuracy of the model; baseline model weights; recent model weights; a number of training samples; a layer-wise neuron count (or in other words, the number of neurons per layer an a layer-by-layer basis); and a learning rate of the neural network. The baseline parameters of the model can be stored and can serve as variables in the watermark equation discussed above. With respect to the model weights, the model weights which correspond to the optimum weights of the model can be stored. The model weights are maintained for each layer in order for the watermark to be verified in a layer wise manner. Another parameter at the layer level is the number of input features and output features at each layer. The accuracy along with the number of training samples for which the model is deployed also can be recorded.

Second, calculation of a layer-wise neuron count can be performed. The neuron count distribution of each layer is a parameter in the watermark equation. By including the neuron count in the watermark equation, the flow of information between the layers of a neural network is implicated. A function of the input and output features can be employed to denote the number of neurons in each layer.

Third, a threshold can be determined to consider watermarking neurons in each layer. In order to preserve the watermark against modifications such as pruning, variation of the watermark’s accuracy should be minimal. Minimizing variation of the watermark’s accuracy can be accomplished by selecting the most promising neurons in each layer. Selecting the most promising neurons in each layer can include consideration of two aspects: (1) the number of promising neurons to be considered, and (2) the rule or algorithm to choose them so that the effect on the watermark is minimal. For example, a class of pruning algorithms can be selected with respect to neuron ranking algorithms that are readily available and can be used to find promising neurons which are least likely to be pruned. These algorithms are varied in terms of complexity and resource requirement, are readily obtainable and well known to those skilled in the art, and therefore it is not necessary to describe in detail such algorithms. The rule or algorithm chosen is also considered when choosing the quantity of promising neurons to be considered.

In some embodiments, the rule or algorithm comprises a threshold value, which can be a mean of weights.

Fourth, the promising neurons can be identified. The promising neurons includes those neurons that have the least probability of being pruned. As explained above with reference to the third operation, a ranking algorithm can be used that provides a specific number of promising neurons as an output. The identified promising neurons are the layer-wise neuron count used in the watermark equation.

In some embodiments, if the rule or algorithm comprises a threshold value comprising a mean of weights, the ranking algorithm evaluates the neuron weights against the threshold value to select the qualifying neurons as the promising neurons.

Fifth, a layer-wise watermark can be generated which can be a characteristic of a water retention curve discussed herein. The parameters are mapped to the watermark equation. The final result of the watermark equation is maintained as a vector to obtain a single watermark measure that characterizes that layer uniquely.

For the watermark generation, the baseline parameters considered for the equation are extracted, when the neural network has attained convergence. As a consequence, the generated watermark is a measure based on the value of the baseline parameters.

Exemplary pseudocode for watermark generation is as follows:
S = snapshot (M)
S contains baseline model weights λ₀,
current model weights λ,
input -output features I, O,
optimal baseline accuracy ρ,
and number of training samples ω.
N <- Layer-wise neuron count (I, O)
Watermark_baseline <-watermark_measure (λ₀, λ, N, ρ, ω).

Verification of the watermark is now discussed.

The generated watermark can be verified against a watermark calculated for a target suspicious model (also referred to herein as a “target model”, a “second model”, a “second neural network”, a “second AI model”, and/or “another artificial intelligence model”). Based on the verification a conclusion can be drawn regarding the ownership of target model from the extent of correlation between the watermark calculated for the target model, and the watermark generated for the original model. An adversary may have a limited choice for subjecting a stolen model through fine-tuning or pruning to ensure that the functionality of model is not lost. In some embodiments, W* is the watermark value computed from the watermark equation when a minimum number of promising neurons are removed from the model.

In some embodiments, the original model’s watermark is W, ΔW is the difference |W - W^{∗}| and, thus, the threshold for the watermark is set as [W - ΔW, W + ΔW].

Verification of the watermark can include five operations for verifying a watermark for a target model against the generated watermark for the original model.

First, parameters of the target model can be acquired. A snapshot of the target model can capture the current state of the target model, including current parameter values of the target model.

In addition to this, the input and output features of the target model can be captured. The captured information includes structural information about the target model.

Second, calculation of layer-wise neuron count can be performed. The neuron count distribution of each layer is a parameter in the watermark equation. By including the neuron count in the watermark equation, the flow of information between the layers of a neural network is implicated. A function of the input and output features can be employed to denote the number of neurons in each layer.

Third, calculation of parameters of the water equation can be performed. For each layer in the target model, a suitable neuron ranking algorithm is applied to extract a set of neurons to be utilized for watermark value calculation for the target model. Readily ascertainable algorithms are varied in terms of complexity and resource requirements and are well known to those skilled in the art, and therefore it is not necessary to describe in detail such algorithms. Using the calculated parameters, a water retention value for each layer is ascertained.

Fourth, a layer-wise watermark can be generated for the target model. The watermark can be determined by using a threshold quantity on the watermark value. The whole set of watermarking values for all layers forms the watermark for the target model.

Fifth, the watermark of the original model and the target model can be compared. For example, the calculated watermark value for the target model is compared with the watermark generated (which can be previously stored) for the original model.

In an exemplary embodiment, the original model belongs to an owner and has been stolen and mildly modified for its present use as a target model. The result of the watermark verification includes two outcomes:

A match of the watermarks is found, which verifies that the target model is a stolen model.

No match of the watermarks is found, which verifies that the target model does not belong to the owner.

In a case of a black box attack, an original model can be poisoned, or a well-crafted set of queries can be used to copy the model weights in order to create a replica of the same. In some embodiments, both cases can be handled by comparing the present model weights of the target model to the baseline weights for the original model in the watermark equation, and by placing the watermark external to the original model, respectively.

Exemplary pseudocode for watermark verification is as follows:
S′ = snapshot (M′)
S′ contains target model’s weights λ′,
baseline model weights λ₀’,
input -output features I′, O′,
baseline accuracy ρ′,
and number of training samples ω′.
N <- Layer-wise neuron count (I′, O′)
Watermark_target <-watermark_measure (λ_{0⍘}, λ′, N′, ρ′, ω′)
verify (watermark_baseline, watermark_eqn, displacement_error-threshold).

In various embodiments, the baseline parameters of the watermark equation pertain to common characteristics of all neural network architectures. As a consequence, the watermark equation can have wide applicability, irrespective of the nature of and applications for a particular neural network.

In various embodiments, the generated watermark can be verified against the watermark calculated for a target model. Conclusions can be drawn regarding the ownership of a target model from the extent of correlation between the watermark value calculated for the target model, and the watermark generated for the baseline model.

The functioning of the watermarking process does not interfere with the working of the baseline model, thus enabling parallel working on the watermark and/or the baseline model.

In a federated learning setting, continuous changes in the local models may make it difficult to find a fit for the methods provided herein. In some embodiments of the present disclosure, an owner’s model has no or little need to undergo substantial changes in its trained form. As a consequence, fine tuning or pruning performed by an adversary would not deviate the values of watermark equation terms, thus maintaining the value of the watermark. In other embodiments, the watermark equation can be applied to a global model, using parameters of the global model, and can be verified using the method described herein.

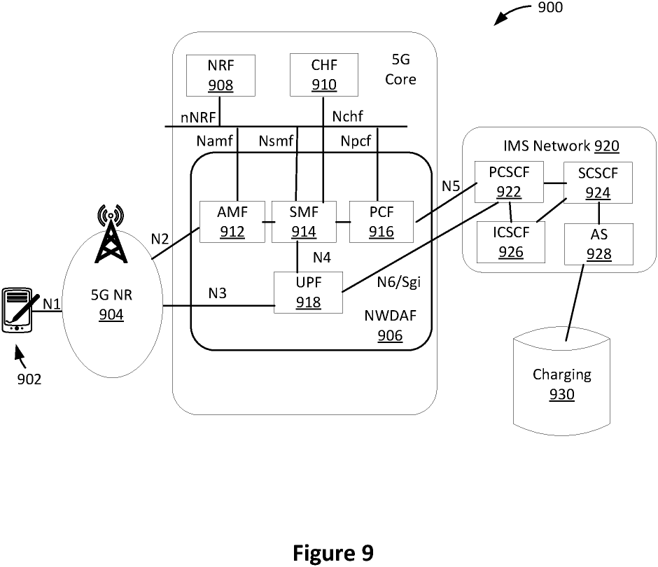

In some embodiments, the method provided is applied in telecommunication use-cases including, for example, elephant flow prediction, congestion flow classification, etc. deployed at a network data analytics function (NWDAF), where these models can act as a company’s unique selling propositions (USP). As a consequence, protecting them may become a high priority mission. FIG. 9 illustrates an exemplary embodiment in a 3GPP context on a packet core for a 5G telecommunication network 900 with the method managed within NWDAF 906 in addition to life cycle management process of ML algorithms. The 5G architecture and components of FIG. 9 are described in 3GPP TS 29.520 and are well known to those skilled in the art.

Entities invest in products and technologies which employ AI and deep learning techniques. Methods of the present disclosure may protect AI and deep learning property in multiple ways. First and foremost, existing deep learning models may be secured. Furthermore, watermark verification may detect tampering including, for example, theft and infringement.

In various embodiments. the adaptation of retentivity to neural networks compactly and intuitively describes the watermarking method as an outcome of the cascade of data through the network. General characteristics of a neural network are incorporated in generating a watermark that is dependent on both structural and functional aspects of the model.

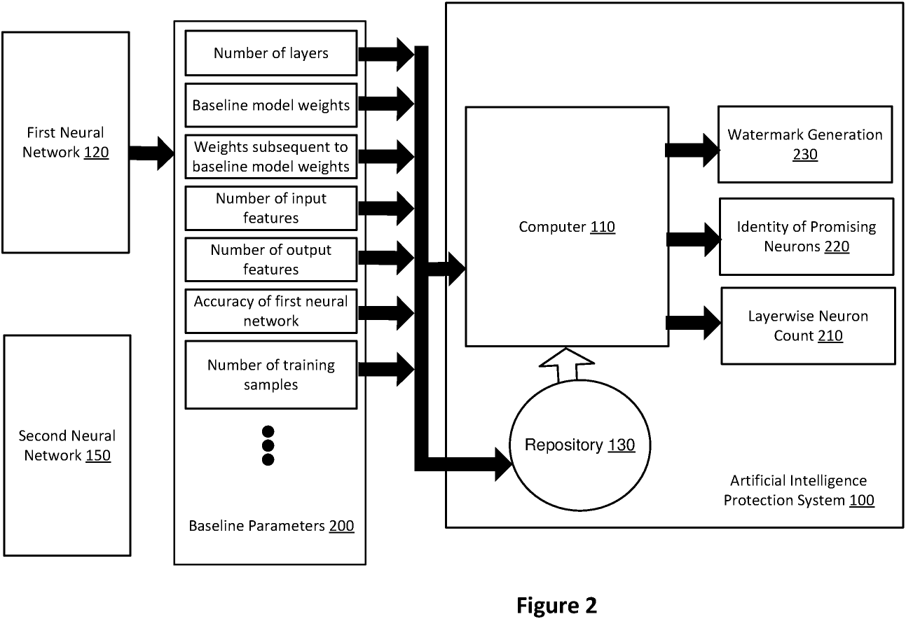

FIG. 2 illustrates an operational view of the AI protection system 100 that is processing baseline parameters 200 of the first neural network 120 of the communications network 140.

Referring to FIG. 2, a computer 110 can use baseline parameters 200 to calculate a layerwise neuron count 210, identify promising neurons 220, and generate watermark 230. The baseline parameters 200 for the first neural network 120 that can be input to the computer 110 for processing, can include, without limitation, a number of layers, baseline model weights, weights subsequent to the baseline model weights, a number of input features, a number of output features, an accuracy, and a number of training samples, etc.

The baseline parameters 200 can be input to the repository 130 for storage and may also be input to computer 110. The computer 110 operates to calculate a layerwise neuron count 210, identify promising neurons 220, and generate watermark 230.

During operation of first neural network 120, the input features are provided to input nodes of the neural network 120. The neural network 120 processes the inputs to the input nodes through neural network hidden layers which combine the inputs, as will be described below, to provide outputs for combining by an output node. The output node provides an output value responsive to processing through the input nodes of the neural network a stream of input features.

As will be explained in further detail below, the AI protection system 100 may generate an alert notification for protection of the first neural network 120.

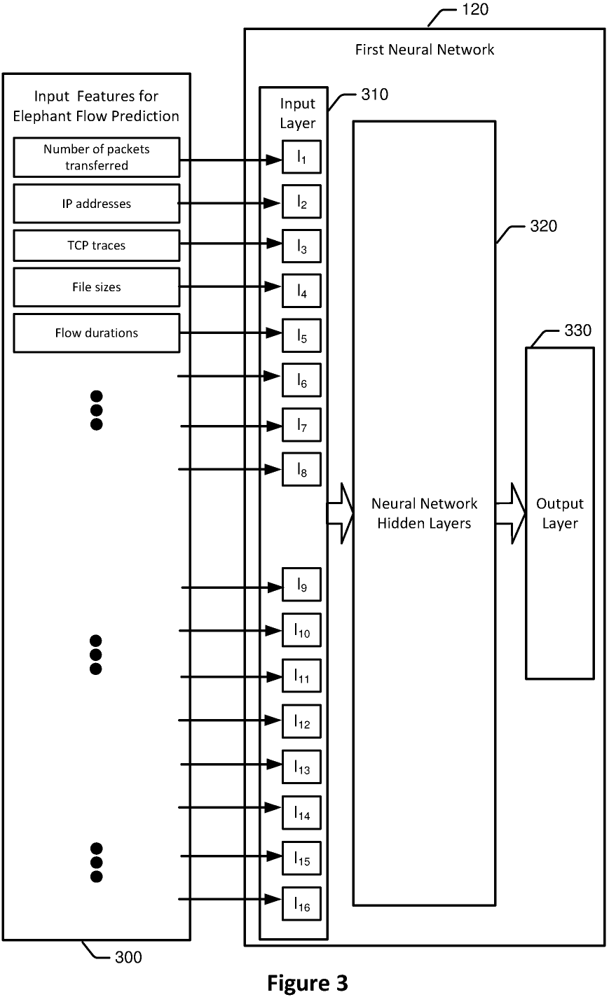

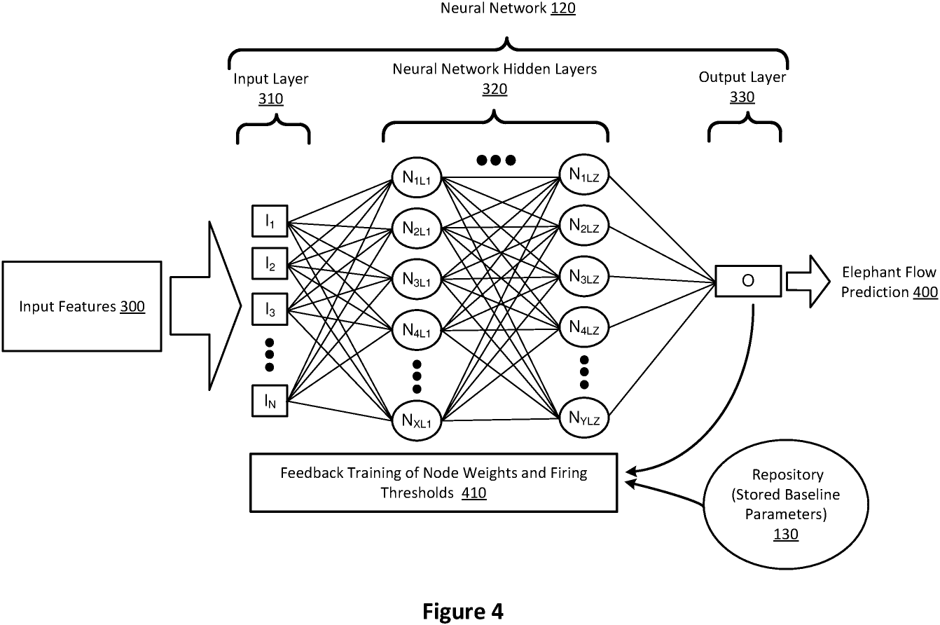

FIG. 3 illustrates that the neural network 120 can include an input layer 310 with input nodes “I”, a sequence of hidden layers 320 each having a plurality of combining nodes, and an output layer 330 having an output node. Each of the input nodes “I” can be connected to receive a different type of the input features 300, such as shown in FIG. 3. Example operations of the combining nodes and output node are described in further detail below with regard to FIG. 4.

In the non-limiting illustrative embodiment of FIG. 3, the first neural network 120 is communicatively connected to a telecommunication network, such as a 5G network, for predicting elephant flow user devices and adjusting a parameter of the telecommunications network based on the prediction. An elephant flow user device includes, for example, a user device that may utilize a large bandwidth of the telecommunication network and/or other resources of the telecommunication network relative to other user devices (e.g., mouse user devices). For example, the input features for elephant flow prediction 300 can include a number of packets transferred, IP addresses of user devices, TCP traces, file sizes of user devices, flow durations of user devices, etc.

Various operations that may be performed by a processor(s) of the first neural network 120 for the exemplary embodiment of elephant flow prediction will now be explained.

The operations include providing to the input nodes “I” in input layer 310 of the neural network 120 the input features for elephant flow prediction. The operations further include outputting an elephant flow prediction value from the output node 330 of the neural network 120. The operations further include adapting weights and/or firing thresholds, which are used by at least the input nodes “I” in input layer 310 of the neural network circuit 120 to generate outputs to the combining nodes of a first one of the sequence of the hidden layers.

The elephant flow prediction value can then be used to adjust a parameter(s) of the telecommunication network and/or user device for an identified predicted elephant flow user device. For example, quality of video displayed on the predicted elephant flow user device can be lowered.

Although the embodiment of FIG. 3 shows a one-to-one mapping between each input feature and one input node of the input layer 310, other embodiments are not limited thereto. For example, in one embodiment, a plurality of different types of input features can be combined to generate a combined input metric that is input to one input node of the input layer 310. Alternatively or additionally, in a second embodiment, a plurality of input features over time can be combined to generate a combined input metric that is input to one input node of the input layer 310.

FIG. 4 is a block diagram and data flow diagram of an exemplary first neural network 120 that can be used in the AI protection system 100 to generate an elephant flow prediction 400 and perform feedback training of the node weights and firing thresholds 410 of the input layer 310, the neural network layer 320 and the output layer 330.

Referring to FIG. 4, the neural network 120 includes the input layer 310 having a plurality of input nodes, the sequence of neural network hidden layers 320 each including a plurality of weight nodes, and the output layer 330 including an output node. In the particular non-limiting example of FIG. 4, the input layer 310 includes input nodes I1 to IN (where N is any plural integer). The input features 300 are provided to different ones of the input nodes I1 to IN. A first one of the sequence of neural network hidden layers 320 includes weight nodes N1L1 (where “1L1” refers to a first weight node on layer one) to NXL1 (where X is any plural integer). A last one (“Z”) of the sequence of neural network hidden layers 320 includes weight nodes N1LZ (where Z is any plural integer) to NYLZ (where Y is any plural integer). The output layer 330 includes an output node O.

The neural network 120 of FIG. 4 is an example that has been provided for ease of illustration and explanation of one embodiment. Other embodiments may include other predictions and any non-zero number of input layers having any non-zero number of input nodes, any non-zero number of neural network layers having a plural number of weight nodes, and any non-zero number of output layers having any non-zero number of output nodes. The number of input nodes can be selected based on the number of measured performance metrics 200 and forecasted performance metrics 300 that are to be simultaneously processed, and the number of output nodes can be similarly selected based on the number of network operation fault prediction values that are to be simultaneously generated therefrom.

The first neural network 120 operates the input nodes of the input layer 310 to each receive different input features 300. Each of the input nodes multiply metric values that are input by a weight that is assigned to the input node to generate a weighted metric value. When the weighted metric value exceeds a firing threshold assigned to the input node, the input node then provides the weighted metric value to the combining nodes of the first one of the sequence of the hidden layers 320. The input node does not output the weighted metric value if and until the weighted metric value exceeds the assigned firing threshold.

During operation, the interconnected structure between the input nodes 310, the weight nodes of the neural network hidden layers 320, and the output nodes 330 may cause the characteristics of each inputted feature to influence the elephant flow prediction 400 generated for all of the other inputted features that are simultaneously processed.

A training module 410 uses feedback of stored fault values from the repository 130 to adjust the weights and the firing weights of the input nodes of the input layer 310, and may further adjust the weights and the firing weights of the hidden layer nodes of the hidden layers 320 and the output node of the output layer 330.

Furthermore, the first neural network 120 operates the combining nodes of the first one of the sequence of the hidden layers 320 using weights that are assigned thereto to multiply and mathematically combine weighted metric values provided by the input nodes to generate combined metric values, and when the combined metric value generated by one of the combining nodes exceeds a firing threshold assigned to the combining node to then provide the combined metric value to the combining nodes of a next one of the sequence of the hidden layers 320.

Furthermore, the first neural network 120 operates the combining nodes of a last one of the sequence of hidden layers 320 using weights that are assigned thereto to multiply and combine the combined metric values provided by a plurality of combining nodes of a previous one of the sequence of hidden layers to generate combined metric values, and when the combined metric value generated by one of the combining nodes exceeds a firing threshold assigned to the combining node to then provide the combined metric value to the output node of the output layer 330.

Finally, the output node of the output layer 330 is then operated to combine the combined metric values to generate the output value used for predicting elephant flow user devices.

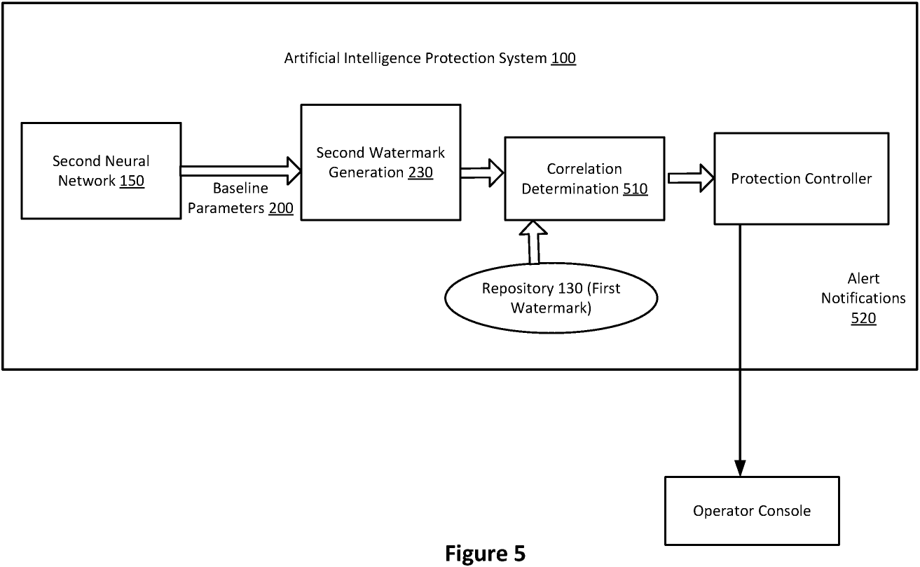

FIG. 5 is a block diagram of operational modules and related circuits and controllers of the AI protection system 100 that are configured to operate during operation of system 100.

Referring to FIG. 5, baseline parameters 200 are acquired from a second neural network 150. A watermark is generated 230 for the second neural network 150 (referred to as a second watermark). A comparison of the watermark generated for the first neural network 120 (referred to as a first watermark) and the second watermark is performed to determine 510 an extent of correlation between the first watermark and the second watermark. In some embodiment, the first watermark can be accessed from repository 130. When the correlation determination 510 results in a match of the first watermark and the second watermark, an alert notification 520 can be generated. In some embodiments, the match includes a match of a value of each of the first watermark and the second watermark that is within a range of the threshold described herein. The alert notification can be provided to an operator console.

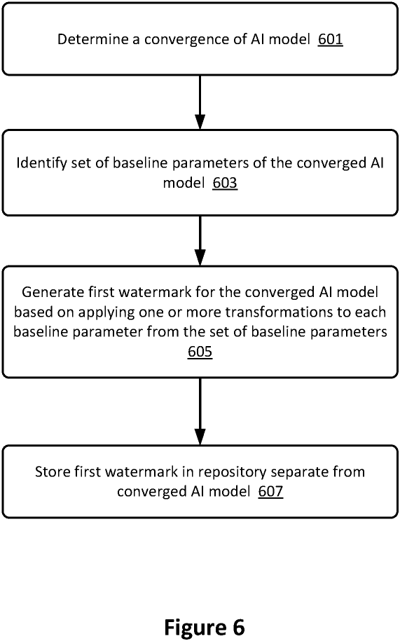

Now that the operations that the various components have been described, operations specific to the computer 110 of AI protection system 100 (implemented using the structure of the block diagram of FIG. 1) for performing watermark generation and watermark verification will now be discussed with reference to the flow charts of FIGS. 6-8 according to various embodiments of the present disclosure. For example, modules may be stored in memory 116 of FIG. 1, and these modules may provide instructions so that when the instructions of a module are executed by respective computer processing circuitry 112, processing circuitry 112 performs respective operations of the flow charts. Each of the operations described in FIGS. 6-8 can be combined and/or omitted in any combination with each other, and it is contemplated that all such combinations fall within the spirit and scope of this disclosure.

Referring first to FIG. 6, a method is provided for protecting an AI model (e.g., first neural network 120) from tampering. The method includes determining 601 a convergence of the AI model. Responsive to the determining, the method further includes identifying 603 a set of baseline parameters of the converged AI model. The method further includes generating 605 a first watermark for the converged AI model based on applying one or more transformations to each baseline parameter from the set of baseline parameters. The first watermark includes a value external to the converged AI model.

In some embodiments, the method further includes storing 607 the first watermark in a repository 130 separate from the converged AI model.

In some embodiments, the converged AI model comprises a converged neural network.

In some embodiments, the set of baseline parameters includes one or more of: a number of layers in the converged neural network; a set of baseline model weights for each layer in the converged neural network; a number of input features at each layer in the converged neural network; a number of output features at each layer in the converged neural network; an accuracy of the converged neural network; a number of training samples for the converged neural network; and a learning rate of the converged neural network.

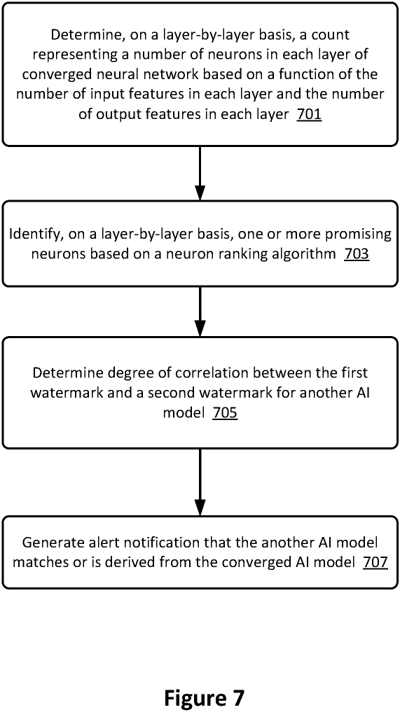

Referring now to FIG. 7, in some embodiments the method further includes determining 701, on a layer-by-layer basis, a count threshold value representing a number of neurons in each layer of the converged neural network based on a function of the number of input features in each layer and the number of output features in each layer, the function comprising a ratio of the number of input values in each layer to the number of output values in each layer. The method further includes identifying 703, on a layer-by-layer basis, one or more promising neurons based on a neuron ranking algorithm.

In some embodiments, the one or more transformations includes generating, on a layer-by-layer basis, a layer-wise watermark based on solving the equation

$$W = l o {g}_{∝} \left(λ 0 + \frac{{λ}_{0}}{{\left[1 + {\left[\left(ω\right) \left(ρ\right)\right]}^{n}\right]}^{1 - 1 / n}}\right)$$

for each layer, wherein w comprises the layer-wise watermark value, |ρ| comprises a baseline accuracy, λ₀ comprises a baseline model weight, ω comprises the number of training samples, n comprises the layer-wise neuron count, and ∝ comprises a learning rate of the converged AI model. The method further includes maintaining the layer-wise watermark for each layer as a vector.

In some embodiments, the method further includes determining 705 a degree of correlation between the first watermark and a second watermark for another AI model. The degree of correlation includes a measure of whether the another AI model matches or is derived from the converged AI model.

In some embodiments, the determining 705 a degree of correlation is based on: generating, on a layer-by-layer basis, a modified watermark for each layer of the converged AI model having the one or more promising neurons removed from the first converged AI model. The method further includes calculating a delta value, on a layer-by-layer basis, of a difference between the first watermark and the modified watermark. The method further includes setting a watermark threshold for the converged AI model. The watermark threshold includes a range defined as a difference between the value of the first watermark less the delta value and the value of the first watermark plus the delta value. The method further includes calculating a value of the second watermark. The method further includes determining whether the value of the second watermark falls within the watermark threshold, wherein falls within the watermark threshold indicates that the another AI model matches or is derived from the converged AI model.

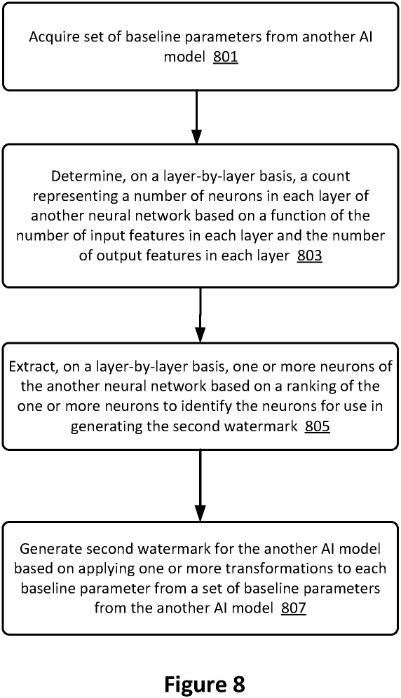

Referring now to FIG. 8, in some embodiments, the method further includes acquiring 801 a set of baseline parameters from the another AI model. The method further includes generating 807 the second watermark for the another AI model based on applying one or more transformations to each baseline parameter from a set of baseline parameters from the another Al model.

In some embodiments, the another AI model comprises another neural network model.

In some embodiments, the set of baseline parameters include one or more of: a number of layers in the another neural network; a set of baseline model weights for each layer in the another neural network; a set of model weights for each layer of the another neural network; a number of input features at each layer in the another neural network; a number of output features at each layer in the another neural network; an accuracy of the another neural network; a number of training samples for the another neural network; and a learning rate of the another neural network.

In some embodiments, the method further includes determining 803, on a layer-by-layer basis, a count representing a number of neurons in each layer of the another neural network based on a function of the number of input features in each layer and the number of output features in each layer, the function comprising a ratio of the number of input values in each layer to the number of output values in each layer. The method further includes extracting 805, on a layer-by-layer basis, one or more neurons of the another neural network based on a ranking of the one or more neurons to identify the neurons for use in generating the second watermark.

In some embodiments, the one or more transformations includes generating, on a layer-by-layer basis, a layer-wise watermark based on solving the equation

$$W = l o {g}_{∝} \left(λ + \frac{{λ}_{0} - λ}{{\left[1 + {\left[\left(ω\right) \left(ρ\right)\right]}^{n}\right]}^{1 - 1 / n}}\right)$$

for each layer, wherein w comprises the layer-wise watermark value, |ρ| comprises a baseline accuracy, λ_0 comprises a baseline model weight, λ comprises a recent model weight, ω comprises the number of training samples, n comprises the layer-wise neuron count, and ∝ comprises a learning rate of the another AI model. The method further includes maintaining the layer-wise watermark for each layer as a vector.

In some embodiments, the method further includes generating 707 an alert notification that the another AI model matches or is derived from the converged AI model.

In some embodiments, the AI model includes at least one of: an elephant flow prediction for a telecommunications network; and a congestion flow classification for a telecommunications network.

Various operations from the flow charts of FIGS. 6-8may be optional with respect to some embodiments of an AI protection system and related methods. For example, operations of block 607 of FIG. 6 may be optional, and the operations of blocks 701-707 of FIG. 7 and blocks 801-807 of FIG. 8 may be optional.

In the above-description of various embodiments of the present disclosure, it is to be understood that the terminology used herein is for the purpose of describing particular embodiments only and is not intended to be limiting of present inventive concepts. Unless otherwise defined, all terms (including technical and scientific terms) used herein have the same meaning as commonly understood by one of ordinary skill in the art to which present inventive concepts belong. It will be further understood that terms, such as those defined in commonly used dictionaries, should be interpreted as having a meaning that is consistent with their meaning in the context of this specification and the relevant art and will not be interpreted in an idealized or overly formal sense unless expressly so defined herein.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” includes any and all combinations of one or more of the associated listed items.

It will be understood that although the terms first, second, third, etc. may be used herein to describe various elements/operations, these elements/operations should not be limited by these terms. These terms are only used to distinguish one element/operation from another element/operation. Thus, a first element/operation in some embodiments could be termed a second element/operation in other embodiments without departing from the teachings of present inventive concepts. The same reference numerals or the same reference designators denote the same or similar elements throughout the specification.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks. Accordingly, embodiments of present inventive concepts may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of inventive concepts. Moreover, although some of the diagrams include arrows on communication paths to show a primary direction of communication, it is to be understood that communication may occur in the opposite direction to the depicted arrows.

Many variations and modifications can be made to the embodiments without substantially departing from the principles of the present inventive concepts. All such variations and modifications are intended to be included herein within the scope of present inventive concepts. Accordingly, the above disclosed subject matter is to be considered illustrative, and not restrictive, and the examples of embodiments are intended to cover all such modifications, enhancements, and other embodiments, which fall within the spirit and scope of present inventive concepts. Thus, to the maximum extent allowed by law, the scope of present inventive concepts are to be determined by the broadest permissible interpretation of the present disclosure including the examples of embodiments and their equivalents, and shall not be restricted or limited by the foregoing detailed description.

1. A computer-implemented method for protecting an artificial intelligence (AI) model from tampering, the method comprising:
determining a convergence of the AI model;
responsive to the determining, capturing a snapshot of a set of baseline parameters of the converged AI model; and
generating a first watermark for the converged AI model based on applying one or more transformations to each baseline parameter from the set of baseline parameters, wherein the first watermark comprises a value external to the converged AI model.

2. The method of claim 1, further comprising:
storing the first watermark in a repository separate from the converged AI model.

3. The method of claim 1, wherein the converged AI model comprises a converged neural network.

4. The method of claim 1, wherein the set of baseline parameters comprises one or more of:
a number of layers in the converged neural network;
a set of baseline model weights for each layer in the converged neural network;
a number of input features at each layer in the converged neural network;
a number of output features at each layer in the converged neural network;
an accuracy of the converged neural network;
a number of training samples for the converged neural network; and
a learning rate of the converged neural network.

5. The method of claim 1, further comprising:
determining, on a layer-by-layer basis, a count representing a number of neurons in each layer of the converged neural network based on a function of the number of input features in each layer and the number of output features in each layer, the function comprising a ratio of the number of input values in each layer to the number of output values in each layer; and
identifying, on a layer-by-layer basis, one or more promising neurons based on a neuron ranking algorithm.

6. The method of claim 1, wherein the one or more transformations comprises:
generating, on a layer-by-layer basis, a layer-wise watermark based on solving the equation
$$W = l o {g}_{∝} \left(λ 0 + \frac{{λ}_{0}}{{\left[1 + {\left[\left(ω\right) \left(ρ\right)\right]}^{n}\right]}^{1 - 1 / n}}\right)$$
for each layer, wherein w comprises the layer-wise watermark value, |ρ| comprises a baseline accuracy, λ₀ comprises a baseline model weight, ω comprises the number of training samples, n comprises the layer-wise neuron count, and ∝ comprises a learning rate of the converged AI model; and
maintaining the layer-wise watermark for each layer as a vector.

7. The method of claim 1, further comprising:
determining a degree of correlation between the first watermark and a second watermark for another AI model, wherein the degree of correlation comprises a measure of whether the another AI model matches or is derived from the converged AI model.

8. The method of claim 7, wherein the determining a degree of correlation is based on:
generating, on a layer-by-layer basis, a modified watermark for each layer of the converged AI model having the one or more promising neurons removed from the converged AI model;
calculating a delta value, on a layer-by-layer basis, of a difference between the first watermark and the modified watermark;
setting a watermark threshold for the converged AI model, wherein the watermark threshold comprises a range defined as a difference between the value of the first watermark less the delta value and the value of the first watermark plus the delta value;
calculating a value of the second watermark; and
determining whether the value of the second watermark falls within the watermark threshold, wherein falls within the watermark threshold indicates that the another AI model matches or is derived from the converged AI model.

9. The method of claim 7, further comprising:
acquiring a set of baseline parameters from the another AI model;
generating the second watermark for the another AI model based on applying one or more transformations to each baseline parameter from a set of baseline parameters from the another AI model.

10. The method of claim 7, wherein the another AI model comprises another neural network model.

11. The method of claim 7, wherein the set of baseline parameters comprise one or more of:
a number of layers in the another neural network;
a set of baseline model weights for each layer in the another neural network;
a set of model weights for each layer of the another neural network;
a number of input features at each layer in the another neural network;
a number of output features at each layer in the another neural network;
an accuracy of the another neural network;
a number of training samples for the another neural network; and
a learning rate of the another neural network.

12. The method of claim 7, further comprising:
determining, on a layer-by-layer basis, a count representing a number of neurons in each layer of the another neural network based on a function of the number of input features in each layer and the number of output features in each layer, the function comprising a ratio of the number of input values in each layer to the number of output values in each layer; and
extracting, on a layer-by-layer basis, one or more neurons of the another AI neural network based on a ranking of the one or more neurons to identify the neurons for use in generating the second watermark.

13. The method of claim 9, wherein the one or more transformations comprises:
generating, on a layer-by-layer basis, a layer-wise watermark based on solving the equation
$$W = l o {g}_{∝} \left(λ + \frac{{λ}_{0} - λ}{{\left[1 + {\left[\left(ω\right) \left(ρ\right)\right]}^{n}\right]}^{1 - 1 / n}}\right)$$
for each layer, wherein w comprises the layer-wise watermark value, |ρ| comprises a baseline accuracy, λ₀ comprises a baseline model weight, λ comprises a recent model weight, ω comprises the number of training samples, n comprises the layer-wise neuron count, and ∝ comprises a learning rate of the another AI model; and
maintaining the layer-wise watermark for each layer as a vector.

14. The method of claim 1, further comprising:
generating an alert notification that the another AI model matches or is derived from the converged AI model.

15. The method of claim 1, wherein the AI model comprises at least one of: an elephant flow prediction for a telecommunications network; and a congestion flow classification for a telecommunications network.

16. An artificial intelligence (AI) protection system for a communication network, the AI protection system comprising:
at least one processor;
at least one memory connected to the at least one processor and storing program code that is executed by the at least one processor to perform operations comprising:
determining a convergence of the AI model;
responsive to the determining, capturing a snapshot of a set of baseline parameters of the converged AI model; and
generating a first watermark for the converged AI model based on applying one or more transformations to each baseline parameter from the set of baseline parameters, wherein the first watermark comprises a value external to the converged AI model.

17. The AI protection system of claim 16, wherein the at least one memory connected to the at least one processor and storing program code that is executed by the at least one processor to perform further operations comprising:
store the first watermark in a repository separate from the converged AI model.

18. (canceled)

19. (canceled)

20. (canceled)

21. (canceled)

22. (canceled)

23. (canceled)

24. The AI protection system of claim 16, wherein the converged AI model comprises a converged neural network.

25. The AI protection system of claim 16, wherein the set of baseline parameters comprises one or more of:
a number of layers in the converged neural network;
a set of baseline model weights for each layer in the converged neural network;
a number of input features at each layer in the converged neural network;
a number of output features at each layer in the converged neural network;
an accuracy of the converged neural network;
a number of training samples for the converged neural network; and
a learning rate of the converged neural network.

26. The AI protection system of claim 16, wherein the at least one memory connected to the at least one processor and storing program code that is executed by the at least one processor to perform further operations comprising:
determine, on a layer-by-layer basis, a count representing a number of neurons in each layer of the converged neural network based on a function of the number of input features in each layer and the number of output features in each layer, the function comprising a ratio of the number of input values in each layer to the number of output values in each layer; and
identify, on a layer-by-layer basis, one or more promising neurons based on a neuron ranking algorithm.
